(19) United States
(12) Patent Application Publication
(10) Pub. No.: US 2006/0023023 A1
(43) Pub. Date: Feb. 2, 2006

(54) Printing using traveling printheads

(76) Inventor: James M. Mattern, Bethany, CT (US)

Correspondence Address: PERMAN & GREEN, 425 POST ROAD, FAIRFIELD, CT, 06824, US

(21) Appl. No.: 11/045,176

(22) Filed: Jan. 28, 2005

Related U.S. Application Data
(60) Provisional application No. 60/591,490, filed on Jul. 27, 2004.

(51) Int. Cl. B41J 23/00

(52) U.S. Cl. 347/37

(57) ABSTRACT

A printing device adapted to print upon a printing media. The printing device has a printing media transport adapted to transport the printing media along a media path; a printhead transport adapted to transport one or more printheads along the media path; and one or more printheads coupled to the printhead transport. The one or more printheads travel in the same direction as the printing media and print upon the media while being transported along the media path.

This application claims the benefit of U.S. Provisional Application No. 60/591,490 filed Jul. 27, 2004 which is incorporated by reference herein in its entirety.

### BACKGROUND OF THE INVENTION

The exemplary embodiments described herein relate to a printing device for high speed printing using moving printheads.

Brief Description of Related Developments

Mailing machines enable users to frank one or more mail items by printing a stamp representing the amount paid by the sender. For example, U.S. Pat. Nos. 5,243,908; 5,683,190; 5,526,271; 6,607,095; 6,050,054; 5,293,465; 5,688,729; all of which are incorporated herein by reference in their entirety; disclose franking machines which may comprise franking heads, feeders, folders and user interfaces as examples.

Barcoded indicia generally occupies about 1 square inch, may require 2 pens and 1 printhead to print, and may require a resolution of approximately 300 DPI. Alignment among multiple devices such as pens and printheads can be difficult to achieve and maintain.

Furthermore, the printing devices themselves print at a rate much slower than typical media transport speeds.

Furthermore, the printing devices themselves print at a rate much slower than typical media transport speeds. For example, a typical printhead may be capable of printing 300 DPI on media travelling at a maximum of 55 inches/second. Using envelopes as an example, this translates to approximately 15 thousand envelopes/hour. Typical media transport devices are capable of moving media at much faster speeds.

It would be advantageous to create a system that is capable of printing at speeds faster than presently available.

### SUMMARY OF THE EXEMPLARY EMBODIMENTS

In accordance with one exemplary embodiment of the present invention, a printing device is provided adapted to print upon a printing media. The printing device has a printing media transport adapted to transport the printing media along a media path; a printhead transport adapted to transport one or more printheads along the media path; and one or more printheads coupled to the printhead transport. The one or more printheads travel in the same direction as the printing media and print upon the media while being transported along the media path.

In accordance with another exemplary embodiment of the present invention, a printing device is provided adapted to print upon mail. The printing device has a printing media transport adapted to transport the mail in a stream of mail along a media path over a printing range; a printhead transport adapted to transport one or more printheads along the media path; and a plurality of printheads coupled to the printhead transport. The plurality of printheads travel in the same direction as the printing media and print upon the mail while being transported along the media path. The printheads are adapted to independently print on the mail over the printing range. The printheads travel at a velocity either faster or slower than that of the stream of mail during a printing operation.

### BRIEF DESCRIPTION OF THE DRAWINGS

The foregoing aspects and other features of the present invention are explained in the following description, taken in connection with the accompanying drawings, wherein:

FIG. 1 shows a block diagram of a system according to the exemplary embodiment.

### DETAILED DESCRIPTION OF THE EXEMPLARY EMBODIMENTS

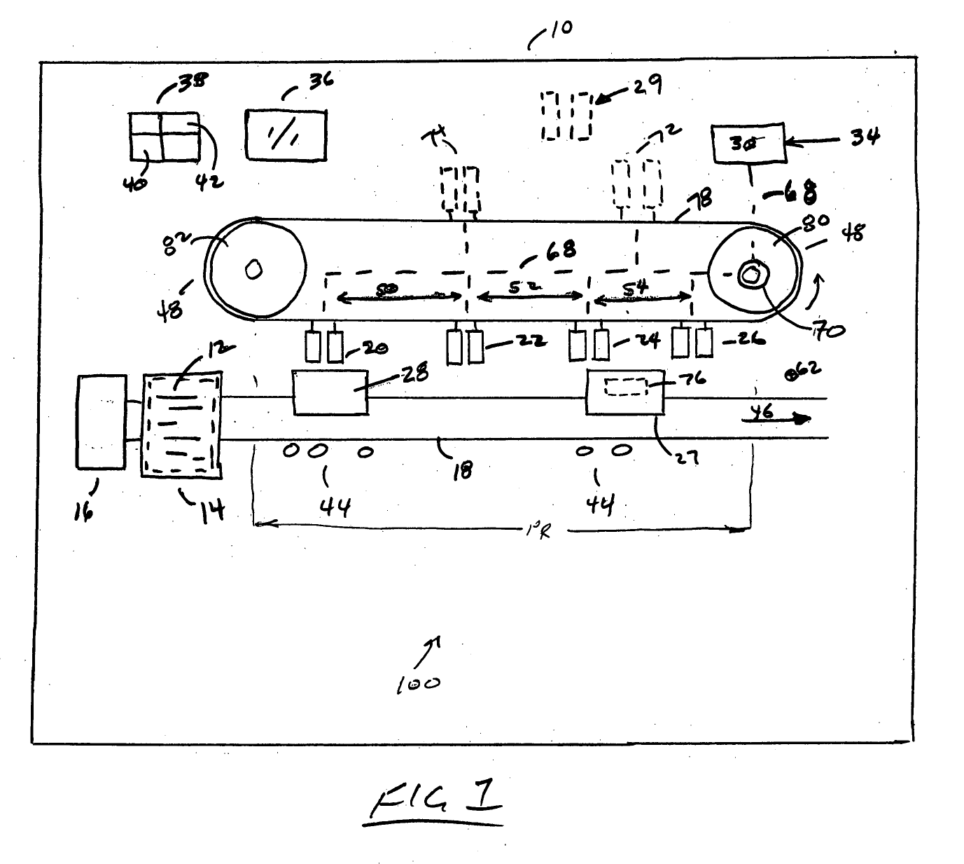

Referring to FIG. 1, there is shown, a schematic block diagram of a printer or mailing machine 10 having a printing device system 100 suitable for practicing the invention disclosed herein and incorporating features in accordance with one exemplary embodiment of the present invention. Although the present invention will be described with reference to the exemplary embodiments shown in the drawings, it should be understood that the present invention can be embodied in many alternate forms of embodiments. In addition, any suitable size, shape or type of elements or materials could be used.

In the exemplary embodiment shown, system 100 may comprise a franking machine having printing device 10. The printing media may for example comprise mail items and the printheads may be controlled to print a postage mark or other indicia on the mail items where the printheads may be part of a meter. Alternately, the device may comprise a printer or copier and media may comprise paper. In alternate embodiments, any other suitable printing application may be provided. In general, printing device 10 prints upon pieces of printing media 12.

The printing device or system 100 may have a printing media buffer 14, a printing media inserter 16, a media path 18, and a plurality of printheads 20, 22, 24, 26 positioned, for example, serially along the media path 18. The device may also include a printing media transport 44 adapted to transport the printing media along the media path 18. As seen in FIG. 1, device 10 has a printhead transport 48 to transport the one or more printheads 20-26 along the media path 18. The one or more printheads 20-26 are coupled to the printhead transport 48.

The printing media inserter 16 allows introduction of printing media into system 100. The inserter 16 may transfer the printing media 12 from the printing media buffer 14 into the media path 18 or to the printing media buffer 14. The media transport 44 feeds the printing media along the media path 18 in a media feed direction 46 at a desired media feed speed. The media feed speed may be fixed or variable and may be controlled by processor 30. A piece 27 or 28 of the printing media 12 traveling along the media path 18 is sequentially printed upon by each of, one of or more than one of the plurality of printheads 20-26. An individual piece of media, for example, an envelope, may be printed upon by each printhead that is enabled to print.

Four printheads 20-26 are shown in FIG. 1, for example purposes, though any suitable number may be used. Printheads 20-26 may be inkjet printheads or any suitable print head or suitable printing marker. In alternate embodiments, more or less printheads may be provided either stationary or movable relative to the media, media transport or relative to each other. The printheads 20-26 are placed with serial distances 50, 52, 54 corresponding to the printhead centerlines and may be at a common pitch or at different pitches and may overlap or coincide with each other. Similarly, the printheads 20-26 may be staggered and stagger distances may be provided corresponding to printhead centerlines (for example, perpendicular to the page) that may be at a common pitch or at different pitches and may overlap or coincide with each other such that the print ranges of each printhead may overlap wholly, partially or not at all.

The printheads 20-26 travel in the same direction as the printing media. In the exemplary embodiment, printheads 20-26 are movable substantially parallel to the feed direction indicated by arrow 46 or alternately another direction (indicated by arrow 62, for example, perpendicular to the page) angled relative to the feed direction 46. The buffer 14, the printing media inserter 16, the plurality of printheads 20-26, and movement of the printheads through transport 48 are controlled from processor and memory 30 for optimum printing media throughput. Processor 30 may direct or apportion data 34 to print heads 20-26 where print heads 20-26 may share data 34 representing a predetermined image 36. Different information may be printed on each media piece or envelope. Alternately, processor 30 may direct or apportion data 38 to print heads 20-26 where print heads 20-26 may share data 38 representing multiple images 40, 42 to be printed upon an individual piece of print media or separately directed to separate pieces of print media. Alternately, image(s) data may be processed and directed generally to print head(s) to be placed on piece(s) of media in any suitable combination. In this manner, printing information may be dynamically allocated among the printheads according to various parameters, for example, printhead capability, colors in a printhead, printhead resolution, media piece position, media type, media speed, print head speed or any other suitable parameter, in order to achieve optimum throughput. The speed of the inserter 16, buffer 14, media path transport 44 and printhead transport 48 may be controlled in conjunction with the information sent to each printhead in order to achieve optimum throughput. As noted before, the media path may travel at a variable speed or at a constant speed depending on a variable set point of transport 44. The inserter, buffer, media path, printhead transport 48 and printheads may communicate with each other over a communication path 68, and may be operated by a controller or processor 30 under the control of one or more programs.

While the media 27, 28 is moved by transport 44 along the media path 46, one or more of the printheads 20-26 travels along with the media (as will be described below) and prints information onto the media along the media path over a printing range PR. As may be realized for the printing range PR is the distance the media travels along media path 19 when the device printheads 20-26 are capable of printing on the media. The printing range PR may be established as desired. For example, the printing range PR may be established substantially by the travel distance between drive rollers 80, 82 of the printhead transport. The printheads may independently print on the media or mail 27, 28 over the printing range and may travel at a speed either faster or slower than media moving on the media path. Any one particular printhead may move relatively faster or slower than the media onto which it is printing. More than one printhead may be used to print out a particular piece of media. The media path is shown as being linear but may be circular or any other shape or configuration. The print heads may travel in a circular motion or in a loop on a conveyor belt as shown in FIG. 1 or otherwise be conveyed along a media path of any suitable shape. The printheads may be conveyed by individual transport mechanisms or may be conveyed by a common transport mechanism 48. In the embodiment shown, transport mechanism 48 has transport belt 78, drive pulley 80 and pulley 82. The transport belt 78 may have print heads 20-26 placed along its length. In the exemplary embodiment shown one transport belt is shown with printheads for example purposes. System 100 may include multiple belts, transporting other printheads, disposed parallel to or sequentially to belt 78 and moving the other printheads for printing along the printing range PR of the media path 18. As noted before, printheads 20-26 are shown arrayed at a constant pitch, but may be located on belt 70 at a varying pitch if desired. The print heads circulate parallel to path 46, around drive pulley 80 and back (for example positions 72, 74) to re circulate. Feed through 70 is provided to pass communication and command signals, power or otherwise and may be an optical, slip ring or other type of feed through or service loop. Feed through 70 comprises a data and communication link between processor 30 and the one or more printheads. Drive pulley 80 may be driven by a motor, such as a stepping motor or encoded servo motor or other suitable drive. In alternate embodiments, more than one printhead transports may be provided driving more than one printhead(s). The transport mechanism(s) may be linked or controlled in conjunction with the media path. The printing media traveling along the media path may be printed upon sequentially or in parallel by at least two printheads. The printing media transport, the printhead transport and the printheads are controlled for optimum printing media throughput. As noted previously, the printing device 100 may comprise a franking machine and the printing media 27 may comprises mail where the printheads are controlled to print a postage mark 76 and where the media path comprises a stream of mail (e.g. media 27, 28) moved by media transport 44 along the media path over the printing range PR. As noted previously, the one or more printheads may travel at a speed either faster or slower than that of the stream of mail during printing operation. The velocity of the print head over the print media represented by the difference between the print head speed and the media speed may be set as desired. For example, the difference between the mail stream or media speed (i.e. speed of media path 8) and printhead speed for a given printhead 20-26 may be established to be substantially equivalent to a desired print speed for a desired print resolution for the given print head. Thus as may be realized, system 100, in effect decouples the media speed from the print resolution of a given printhead, or enables print speed of the printhead to be independent of media speed. In the embodiment shown, the traveling print heads comprise an assembly line of print heads that may travel approximately at the same speed as the media stream, for example, a mail stream where the print head may travel either a little faster or a little slower than the envelope under it. In this embodiment, each print head 20-26 may be able to print ink the entire length of the transport or transport belt and also over a portion of a piece of media or over multiple pieces of media. The one or more printheads may travel in two directions relative to the printing media, for example directions 46 and 62. The printheads may comprise at least two print heads independently movable relative to each other.

As noted before, one or more of the printheads are movable within the media path 46. Also, in this embodiment, one or more of the printheads 20-26 may be movable outside the media path such as for servicing. A printhead service station 29 may be provided for this purpose as further described below. In this embodiment, the printheads may be controlled to allow at least one of the printheads to be inactivated to clean while the remaining printheads are active and where each of the printheads are controlled to be sequentially cleaned. In this embodiment, the one or more printheads may be controlled to allow at least one of the printheads to be inactivated for servicing, such as for replacement, while the remaining printheads are active. In this embodiment, the media throughput may be selectively reduced or remain constant depending on the availability of the remaining active printheads. In the exemplary embodiment, processor 30 may control printheads 20-26 to allow at least one of the printheads to be inactivated for servicing, such as to clean or to be replaced while the remaining printheads are active. In this embodiment, processor 30 may account for any servicing of printheads that may be desired and may reduce speed, throughput or output by a marginal fraction. As noted before, the print head may be moved to a different position 29 for servicing or may be serviced in place via an access (not shown). Cleaning, for example, may involve wiping the print face at a wiping station 29 or at the location where the print head is mounted. Processor 30 may control the media throughput where the media throughput is selectively reduced or remains constant depending on the availability of the remaining active printheads. Each of the printheads may then be controlled to be sequentially cleaned or serviced either randomly or with a predetermined sequence, such as every 500 print cycles for example.

Printheads 20-26 are shown as having two heads each, for example, a black and a colored head. In alternate embodiments, more or less printheads could be provided with each, such as simply a monochrome color. As noted previously, each or all of the printheads may be capable of printing the same color or combination of colors. Alternately, printheads may print different colors or be provided in combinations of groups with the same or different color(s). For example, the printheads may all be monochrome or black. Alternately, the printheads may all be combination color and black. Colors, for example may be Cyan, Yellow and Magenta or Multiple Cyan, Multiple Yellow and Multiple Magenta or RGB or individual or multiple colors. Alternately, printheads of the same or varying colors may be combined in any suitable combination.

The plurality of print heads may be controlled to enable a higher print resolution than the maximum print resolution of any single printhead. In this embodiment, the plurality of print heads of system 100 may be controlled to share data representing a predetermined image where the plurality of printheads sequentially prints interlaced images resulting in the predetermined image on a piece of print media 27 28. A suitable example of a system having more than one printhead printing interlaced or combined images on a piece of media is disclosed in U.S. Patent Application No. 770P011871-US(PAR), filed on the same day herewith, and incorporated by reference herein in its entirety. The higher print resolution may be the product of the desired or maximum print resolution and the number of printheads desired to make the predetermined image of predetermined resolution. Each of the printheads employed to make the predetermined image of predetermined resolution may be capable of printing the same color or combination of colors.

Each of printheads 20-26 may have a desired print resolution at a desired difference between media feed speed and printhead speed or alternately a desired print resolution capability at the relative speed between the print head and the media path. The print resolution of one or more printheads may be fixed or may be adjustable. A piece of the printing media 27, 28 traveling along the media path 18 in the media feed direction 46 at the desired speed relative to the transport 44 and transport 48 may be printed upon by more than one of the plurality of printheads 20-26 to generate image 36 on the piece. In the exemplary embodiment, the print heads 20-26 printing on the piece and the transports 44 and 48 are controlled by processor 30 to enable a higher media feed speed than, for example, a media feed speed supported by stationary printhead(s) capable of a predetermined print resolution for an image of a predetermined resolution. As the piece of printing media travels along the media path, images from separate print heads printing on the piece may be interlaced to produce image 36. Thus, for example, the predetermined resolution of the combined printing may, be the same as or higher than the maximum print resolution capability of any one of the printheads at a given relative speed between the print heads and the media. As a further illustration, the relative speed of piece 28 may be substantially equivalent to the cumulative maximum printing speed of the number of active printheads printing on the piece 28. Here the media speed may be the sum of the print head speed and the operating media feed speed for each of the print heads where the images may also be interlaced. As a further illustration, the higher print resolution may be the product of the maximum print resolution and the number of print heads desired to make the predetermined image of predetermined resolution. In this manner, the plurality of print heads may be controlled to enable a higher print resolution than a given operating print resolution for a given print head.

Three of the four print heads may be active spraying ink at 100 DPI (˜3.5M/S) where the dots are interlaced to form a 300 DPI combined print image 36 on piece 28, data matrix barcode with the fourth print head being cleaned, for example every 500 prints a head may be inactive to wipe and the inactive wiped head becomes active. In this embodiment, each head, for example, sprays 100 DPI; the 300 DPI data matrix is split between 3 print heads. In alternate embodiments, the printheads may be cleaned or serviced in parallel or in serial and parallel combinations or other combinations. As a further illustration, each printhead may print at a reduced resolution. For example, a printhead with an unreduced print resolution of 300 DPI may be operated to print at 150 DPI, with a corresponding increase in print speed and desired media feed speed. Throughput may be increased even further by sharing information among printheads such that each printhead prints at, for example, 150 DPI, but the effective resolution of the finally printed media piece is 300 DPI where the printed images are interlaced. For example, if a single printhead 20-26 is capable of printing 15K/HR @ 300 DPI, then the combined effect of 4 printheads may print 60K/HR @ 300 DPI.

It should be understood that the foregoing description is only illustrative of the invention. Various alternatives and modifications can be devised by those skilled in the art without departing from the invention. One such example is where other configurations of printheads may also be used. Accordingly, the present invention is intended to embrace all such alternatives, modifications and variances which fall within the scope of the appended claims.

What is claimed is:

1. A printing device adapted to print upon a printing media, the printing device comprising:
a frame;
a printing media transport connected to the frame and adapted to transport the printing media along a media path;
a printhead transport connected to the frame; and
at least one printhead movably coupled to the frame by the printhead transport, the printhead transport being adapted to transport the at least one printhead along the media path;
wherein, the at least one printhead travels in the same direction as the printing media moving along the media path for printing upon the media being transported along the media path.

2. The printing device of claim 1 wherein the at least one printhead comprises at least two printheads, and wherein the printing media traveling along the media path is printed upon sequentially or in parallel by the at least two printheads, and wherein the printing media transport, the printhead transport and the printheads are controlled for optimum printing media throughput.

3. A franking machine comprising the printing device of claim 1, wherein the printing media comprises mail and wherein the at least one printhead is controlled to print a postage mark.

4. The printing device of claim 1 wherein the printing media comprises mail, and wherein the media path forms a stream of mail.

5. The printing device of claim 4 wherein the at least one printhead travels at a speed either faster or slower than the stream of mail during a printing operation.

6. The printing device of claim 1 wherein the at least one printhead travels in two directions relative to the printing media.

7. The printing device of claim 1 wherein the at least one printhead comprises at least two printheads independently movable relative to each other.

8. The printing device of claim 1 further comprising a data and communication link between a processor and the at least one printhead.

9. The printing device of claim 1 wherein the at least one printhead comprises at least two printheads and wherein at least two the printheads are controlled to allow at least one of the printheads to be inactivated while a remaining printhead is active and wherein each of the at least two printheads are controlled to be sequentially inactivated.

10. The printing device of claim 1 wherein the at least one printhead is controlled to allow the at least one of the printhead to be inactivated for servicing while another remaining printhead of the device is active, and wherein the media throughput may be selectively reduced or remain constant depending on the availability of the other active printhead.

11. A printing device adapted to print upon mail, the printing device comprising:
a printing media transport adapted to transport the mail in a stream of mail along a media path over a printing range;
a plurality of printheads for printing on the mail on the media path over the printing range;
a printhead transport, at least one of the printheads being coupled to and transported by the printhead transport along the media path; and
wherein, the at least one printhead travels in the same direction as the stream of mail and prints upon the mail being transported along the media path, and wherein the at least one printhead travels at a speed either faster or slower than the stream of mail over the printing range.

12. The printing device of claim 11 wherein the mail stream travelling along the media path is printed upon sequentially or in parallel by at least two printheads, and wherein the printing media transport, the printhead transport and the printheads are controlled for optimum printing media throughput.

13. The printing device of claim 11 wherein the plurality of printheads comprises at least two printheads independently movable relative to each other.

14. The printing device of claim 11 wherein the plurality of printheads are controlled to allow at least one of the printheads to be inactivated for servicing while the remaining printheads are active and wherein a mail throughput may be selectively reduced or remain constant depending on the availability of the remaining active printheads.

15. The printing device of claim 11 wherein the at least one printhead has a predetermined print resolution at a predetermined print speed and wherein the difference between speed of the mail stream and the printhead speed is substantially equivalent to the print speed.

16. The printing device of claim 11 wherein each of the plurality of printheads is capable of printing the same color or combination of colors.

17. The printing device of claim 11 wherein each of the plurality of printheads is coupled to and transported by the printhead transport along the media path, and wherein each printhead prints a corresponding mail piece, transported along the media path, over the printing range independently from other printheads.
